(19) United States
(12) Patent Application Publication
(10) Pub. No.: US 2007/0147197 A1
(43) Pub. Date: Jun. 28, 2007

(54) Objective lens actuating apparatus of optical read/write head

(75) Inventors: Chun-Chieh Huang, Chu-Tung (TW); Yu-Chien Huang, Chu-Tung (TW); Jau-Jiu Ju, Chu-Tung (TW); Chau-Yuan Ke, Chu-Tung (TW); Chih-Cheng Wu, Chu-Tung (TW); Tai-Ting Huang, Chu-Tung (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE

(21) Appl. No.: 11/492,870

(22) Filed: Jul. 26, 2006

(30) Foreign Application Priority Data
Dec. 27, 2005 (TW) 094146851

(51) Int. Cl. G11B 7/00

(52) U.S. Cl. 369/44.15

(57) ABSTRACT

An objective lens actuating apparatus is provided for an optical read/write head. The apparatus includes a base; a lens holder floating over the base; an objective lens, fixed on the lens holder; two multi-polar magnets mounted on the base; and two coil plates located between the two magnets and fixed on the lens holder. Each coil plate has a tracking coil, a focusing coil, and a tilting coil, which overlaps different magnetic poles of each magnet. The coils generate Lorentz Forces after currents being input into the coils, so as to drive the lens holder moving or tilting.

### CROSS-REFERENCE TO RELATED APPLICATIONS

This non-provisional application claims priority under 35 U.S.C. § 119(a) on Patent Application No(s). 094146851 filed in Taiwan, R.O.C. on Dec. 27, 2005, the entire contents of which are hereby incorporated by reference.

### BACKGROUND OF THE INVENTION

1. Field of Invention

The present invention relates to an optical read/write head of an optical disk drive, and more particularly, to an objective lens actuating apparatus of an optical read/write head.

2. Related Art

When a Compact Disc (CD) is placed in an optical disk drive, the optical read/write head of the optical disk drive moves along a track to read/write the data of the CD, and transmit the data to a chipset of a host, such as a computer, music Player, video player, so as to be signal processed. During this process, since the CD is rotated fast and the CD itself is not a perfect disc, the data tracks on the CD tend to offset. Therefore, a quick-reacting actuator in the optical read/write head is needed for quickly moving the objective lens of the optical read/write head to focus on the predetermined data track to be read or written.

In order to make the objective lens focus exactly on the predetermined data track to be read/written on the CD, the optical read/write head must have three actuating modes: (a) focusing: exactly control the distance between the objective lens of the optical read/write head and the surface of the CD, such that the laser beam projected by the optical read/write head focuses accurately on the data track; (b) tracking: moving the objective lens in parallel with the CD, such that the focus of the laser beam falls in the center of the predetermined data track and does not fall outside the data track or on a neighboring data track; (c) tilting: because the aberration result from the deformation of the CD makes the focus of the laser beam offset, it is necessary to change the incidence of the laser beam by tilting the objective lens, to compensate the aberration generated by the deformation.

FIG. 1 and FIG. 2 are constructions of a conventional objective lens actuator. A plurality of tracking coils 1c and focusing coils 1d are disposed around a lens holder 1b holding a objective lens 1a. The lens holder 1b floats over a base 1f by supporting with copper wires 1e. Two yokes 1g for fixing two magnets 1h are disposed on the base if, such that the lens holder 1b is located between the two magnets 1h. A current is input into the tracking coils 1c and the focusing coils 1d copper wires 1e, generating Lorentz Force, so as to change the direction of the Lorentz Force by changing the current direction, such that the tracking coils 1c and the focusing coils 1d move the lens holder 1b to carry out tracking, focusing action of linear movement, or generate a force couple onto the lens holder 1b to carry out a tilting action.

However, each coil is disposed independently in this design. It is not easy to carry out miniaturization and to assemble as well. The coils are easily damaged during assembly and the production yield will be decreased. Further, since the coils are disposed independently, the whole rigidity of the actuating apparatus will be reduced, such that the sensitivity and responding bandwidth will be limited.

Therefore, many designs, such as U.S. patents U.S. Pat. No. 6,493,158, U.S. Pat. No. 6,587,284, and U.S. Pat. No. 6,791,772, adopt coil plates with coils integrated on the surface thereof. The whole rigidity is enhanced with the coil plates. Meanwhile the number of parts is reduced, such that it is easier to assemble. The magnet is polarized with multiple magnetic poles. Therefore, the number of parts will be further reduced. In U.S. Pat. No. 6,791,772, the individual coils must be arranged in a cross-overlapping manner, so the thickness of the coil plate is increased and the difficulty for manufacturing the coil plate is increased as well. In U.S. Pat. No. 6,493,158 and U.S. Pat. No. 6,587,284, in order to make each coil has different functions, the number of the magnetic poles of the magnets is increased, and the length of the line of demarcation among adjacent magnetic poles is short, thus the effective area of the coil is reduced, and power efficiency and force generating of the coil are reduced as well.

### SUMMARY OF THE INVENTION

In view of the above problems, an object of the present invention is to provide an objective lens actuating apparatus for enhancing the sensitivity, structural rigidity, and responding bandwidth, and simplifying the assembly.

In order to achieve the above object, an objective lens actuating apparatus is provided, which includes a base, a supporting device disposed on the base, for supporting a lens holder over the base, wherein the lens holder is used to hold an objective lens.

Two multi-polar magnets, having a plurality of magnetic poles, are disposed on the base. Two coil plates are mounted to the lens holder, and each coil plate is located between the two multi-polar magnets. Each coil plate has a tracking coil, a focusing coil, and a tilting coil fixed on a surface thereof, with each coil overlapping different magnetic poles of each magnet. By inputting current into the coils, force is generated, and the direction of the force is changed by changing the direction of the current, so as to drive the lens holder to move or tilt.

The coil plate of the present invention is not limited to the symmetric arrangement with the same form, and different forms can be adopted to form asymmetric arrangements. The multi-polar magnets can adopt arrangements with different forms, even a single multi-polar magnet can be used to interact with two coil plates simultaneously, for driving the lens holder to move or tilt.

Further, the two coil plates do not need to have all types of coils simultaneously, and coils with different functions can be distributed on different coil plates. For example, in an embodiment of the present invention, a coil plate has the tracking coil and the focusing coil, while the other coil plate has the tracking coil, the focusing coil, and the tilting coil disposed thereon.

Further, the focusing coils and the tilting coils of the present invention are interchangeable. After disposing the same coils, the coils become focusing coils or tilting coils depending on the control of the input current. Of course, the same group of coils can be made as focusing coils or tilting coils simultaneously.

The advantage of the present invention lies in that, multiple coils including focusing coil, tracking coil, and tilting coil are disposed on the same plane of the coil plate to carry out actions such as focusing, tracking, and tilting, accompanied with the arrangement of the multi-polar magnet. Because each coil does not overlap, the structure of the coil plates will be more compact and the assembling procedure will be easier. Also, the sensitivity, structural rigidity, and responding bandwidth of the objective lens actuating apparatus will be enhanced. The design of non-crossed overlapping each coil can also simplify the arrangement form of the magnetic poles of the multi-polar magnets, and cut the cost of the multi-polar magnets. Meanwhile, the effective area of the coil can be increased, and the efficiency and force generating of the coil are increased by appropriate arrangement of the magnetic poles of the multi-polar magnets.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It is to be understood that both the foregoing general description and the following detailed description are exemplary, and are intended to provide further explanation of the invention as claimed.

### BRIEF DESCRIPTION OF THE DRAWINGS

The present invention will become more fully understood from the detailed description given herein below for illustration only, and which thus is not limitative of the present invention, and wherein:

FIG. 1 is an exploded view of a conventional objective lens actuator of a optical read/write head;

FIG. 2 is a perspective view of appearance of the conventional objective lens actuator of a optical read/write head;

FIG. 3 is a perspective view of appearance of an objective lens actuating apparatus of a first embodiment of the invention;

FIG. 4 is an exploded view of a part of the elements of the first embodiment of the invention;

FIG. 5 is a schematic view of the arrangement of poles of the multi-polar magnet with of the first embodiment of the invention;

FIG. 6 is a schematic view of the arrangement of the tracking coil, the focusing coil, and the tilting coil on the coil plate of the first embodiment of the invention;

FIG. 7 is a schematic view of the first embodiment of the invention, in which the magnetic poles of the multi-polar magnet correspond to each coil on the coil plate;

FIG. 8 and FIG. 9 are schematic views of interaction of the tracking coil and the multi-polar magnet of the first embodiment of the invention;

FIG. 10 and FIG. 11 are schematic views of interaction of the focusing coil and the multi-polar magnet of the first embodiment of the invention;

FIG. 12 and FIG. 13 are schematic side views of the lens holder, coil plate, and multi-polar magnet of the first embodiment, disclosing the interaction of the tilting coil and the multi-polar magnet;

FIG. 14 is a schematic view of the arrangement of poles of the multi-polar magnet of a second embodiment of the invention;

FIG. 15 is a schematic view of the arrangement of the tracking coil, the focusing coil, and the tilting coil on the coil plate of the second embodiment of the invention;

FIG. 16 is a schematic view of the second embodiment of the invention, in which the poles of the multi-polar magnetic correspond to each coil on the coil plate;

FIG. 17 is a schematic view of the arrangement of poles of the multi-polar magnet of the third embodiment of the invention;

FIG. 18 is a schematic view of the arrangement of the tracking coil, the focusing coil, and the tilting coil on the coil plate of the third embodiment of the invention;

FIG. 19 is a schematic view of the third embodiment, in which the poles of the multi-polar magnet correspond to each coil on the coil plate;

FIG. 20 is a schematic view of the arrangement of the poles of the multi-polar magnetic of a fourth embodiment of the present invention;

FIG. 21 is a schematic view of the arrangement of the tracking coil, the focusing coil, and the tilting coil on the coil plate of the fourth embodiment of he invention;

FIG. 22 is a schematic view of the fourth embodiment of the invention, in which the poles of the multi-polar magnet correspond to each coil on the coil plate;

FIG. 23 is a perspective view of a fifth embodiment of the invention;

FIG. 24 is an exploded view of a part of the elements of the fifth embodiment of the invention;

FIG. 25 is a schematic view of the arrangement of the poles of the multi-polar magnet of the fifth embodiment of the invention;

FIG. 26 is a schematic view of the arrangement of two tracking coils and the focusing coil on the first coil plate in the fifth embodiment of the invention;

FIG. 27 is a schematic view of the fifth embodiment, in which the poles of the multi-polar magnet correspond to each coil on the first coil plate;

FIG. 28 is a schematic view of the arrangement of two tracking coils, the focusing coil, and two titling coils on the second coil plate in the fifth embodiment of the invention;

FIG. 29 is a schematic view of the fifth embodiment, in which the poles of the multi-polar magnet correspond to each coil on the second coil plate;

FIG. 30 is a schematic view of the arrangement of the tracking coil, the focusing coil, and two titling coils on the first coil plate of a sixth embodiment of the invention;

FIG. 31 is a schematic view of the sixth embodiment, in which the poles of the multi-polar magnet correspond to each coil on the first coil plate;

FIG. 32 is a schematic view of the arrangement of two tracking coils, the focusing coil, and two titling coils on the second coil plate in the sixth embodiment of the invention; and

FIG. 33 is a schematic view of the sixth embodiment, in which the poles of the multi-polar magnet correspond to each coil on the second coil plate.

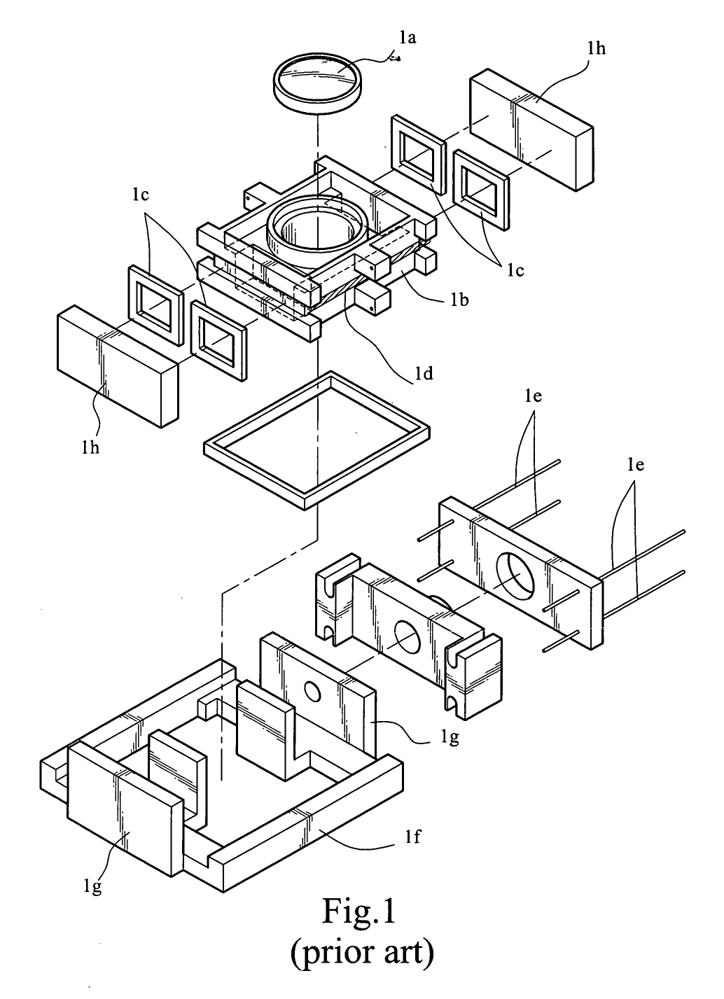

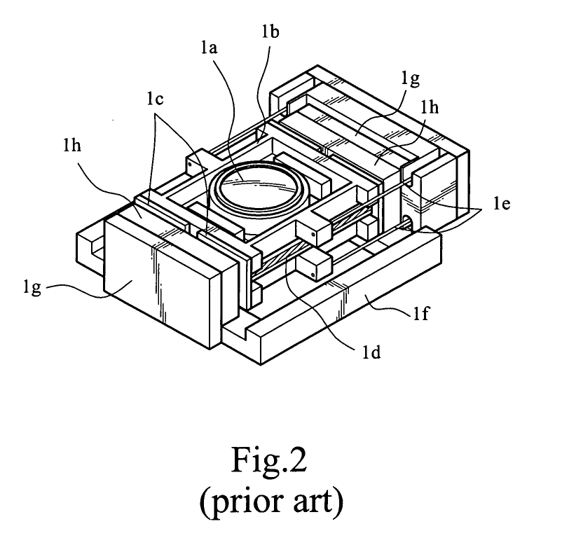

### DETAILED DESCRIPTION OF THE INVENTION

In order to make a further understanding of the object, construction, feature, and function of the present invention, a detailed description will be given below with reference to embodiments.

### The First Embodiment

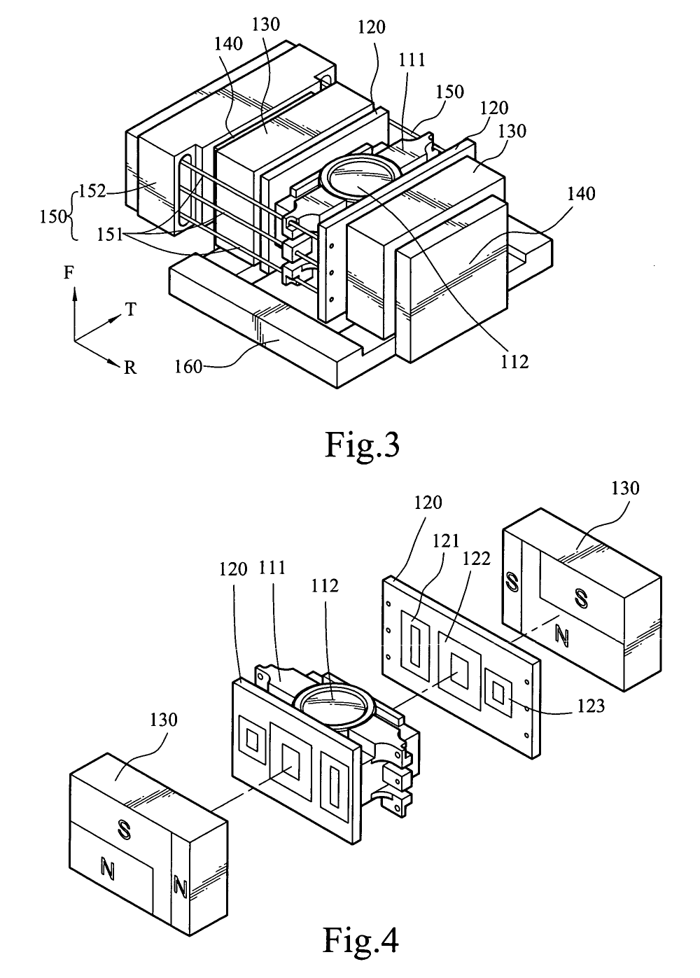

Referring to FIG. 3 and FIG. 4, they are respectively a perspective view of an objective lens actuating apparatus of an optical read/write head provided by the first embodiment of the present invention and an exploded view of part of the elements of the first embodiment. The objective lens actuating apparatus comprises a lens holder 111, an objective lens 112, two coil plates 120, two multi-polar magnets 130, two yokes 140, a supporting device 150, and a base 160. As an illustration, a focusing axis F extending from top to bottom, a tracking axis T parallel to the coil plate 120, a normal direction R of the plate vertical to the focusing axis F and the tracking axis T are defined in the figures.

The objective lens 112, being parallel to the T-R plane, is fixed on the lens holder 111. It can be moved with the lens holder 111 and carries out focusing, tracking, and tilting actions.

The coil plates 120 are mounted onto the two sides of the lens holder 111. A plurality of plane coils including the tracking coil 121, the focusing coil 122, and the tilting coil 123 are disposed on a surface of the coil plates 120. Each of the coils corresponds to the different poles of the multi-polar magnets 130.

The supporting device 150 comprises a plurality of copper wires 151 and a holding seat 152, wherein each copper wire 151 penetrates through two sides of the lens holder 111, with one end connected to the holding seat 152 for receiving a current input, and the other end connected to different coils of the coil plates 120 for powering on the coils, by inputting the current into the coils, to generate Lorentz Force. By changing the direction of the current direction, the direction of the force generated by the tracking coil 121, the focusing coil 122, and the tilting coil 123 change. The holding seat 152 is disposed on one side of the base 160, such that the lens holder 111 can be supported by the copper wires 150 floating over the base 160 in parallel.

Two yokes 140 are disposed on two sides of the base 160 respectively. Each multi-polar magnet 130 is respectively mounted onto the inner side of the two yokes 140. The lens holder 111 and the coil plates 120 are located between the two multi-polar magnets 130. Meanwhile, the two coil plates 120 respectively correspond to the two multi-polar magnets 130. By the supporting of the supporting device 150, the lens holder 111 together with the coil plates 120 and the objective lens 112 floating over the base 160. At this time, as long as the tracking coil 121, the focusing coil 122, and the tilting coil 123 on the coil plates 120 receive the input current, the coils can interact with the different poles of the multi-polar magnets 130, and generate Lorentz Force. The coil plates 120 are driven by the Lorentz Force, and perform vertical and horizontal moving, tilting, and other actions, so as to drive the lens holder 111 to perform vertical and horizontal moving, tilting, and other actions.

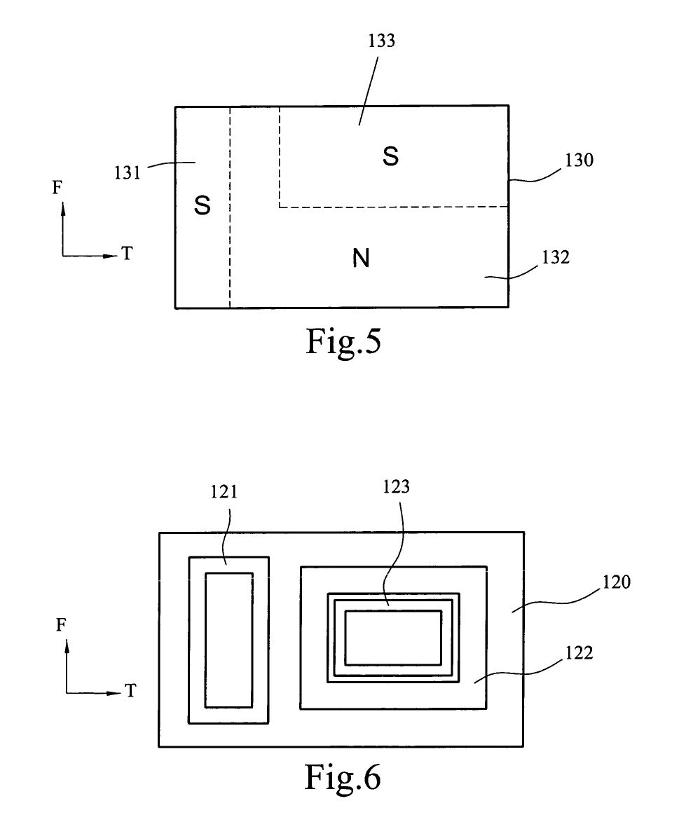

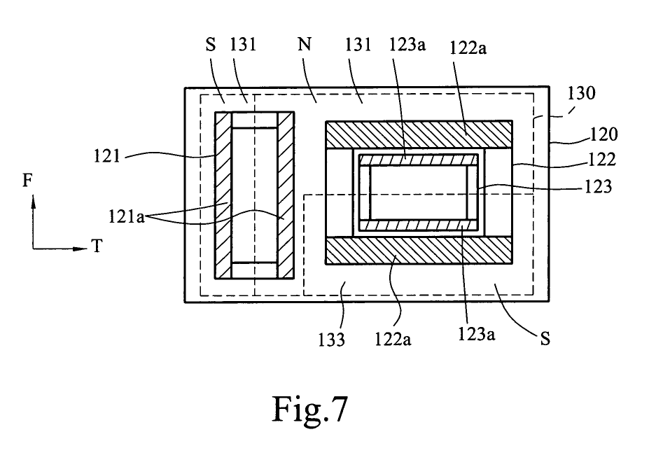

Referring to FIG. 5, FIG. 6, and FIG. 7, wherein FIG. 5 is a schematic view of the arrangement of the poles of the multi-polar magnet 130, FIG. 6 is a schematic view of the arrangement of the tracking coil 121, the focusing coil 122, and the tilting coil 123 on the coil plate 120, and FIG. 7 is a schematic view, in which the poles of the multi-polar magnet 130 correspond to each coil on the coil plate 120.

The tracking coil 121, the focusing coil 122, and the tilting coil 123 are wound parallel to the surface of the coil plate 120 (parallel to the T-F plane). The tracking coil 121 is in the shape of an oval or rectangle, and the length of the tracking coil 121 in the focusing axis F is greater than the length in the tracking axis T. The focusing coil 122 and the tilting coil 123 are also wound parallel to the coil plate 120 (parallel to the T-F plane). The focusing coil 122 surrounds the periphery of the tilting coil 123.

The multi-polar magnet 130 has a plurality of poles; two poles which adjacent to each other are polarize into different polarity. The multi-polar magnet 130 comprises a first pole 131, a second pole 132, and a third pole 133. The first pole 131 is in the shape of a long rectangle, and the length in the focusing axis F is greater than the length in the tracking axis T. The second pole 132 is in the shape of L, which extends in the focusing axis F and the tracking axis T respectively. The first pole 131 borders the second pole 132 at the part extending in the focusing axis F. The border of the first pole 131 and the second pole 132 is parallel to the focusing axis F, and they are respectively polarized into an S magnetic polarity and N magnetic polarity. The extending part of the second pole 132 in the tracking axis T is located on the upper part of the multi-polar magnet 130, and the third pole 133 is located under the extending part, such that the border is parallel to the tracking axis T, wherein the third pole 133 is polarized into an S magnetic polarity.

Referring to FIG. 7, the effective coil areas 121a of the tracking coil 121 overlap the first pole 131 and the second pole 132. After a current is input into the tracking coil 121, a Lorentz Force is generated. By controlling the direction of the current, the direction of the force generated by the tracking coil 121 is changed, such that the Lorentz Force can be used to drive the coil plate 120 to move.

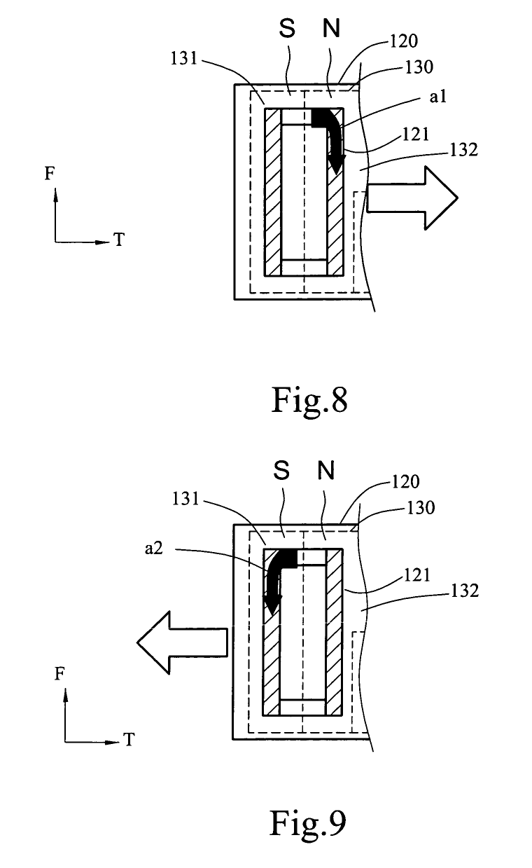

Referring to FIG. 8, when a current a1 is input into the tracking coil 121, generating the Lorentz Force, the tracking coil 121 drives the coil plate 120 to move rightward along the tracking axis T, and simultaneously drives the lens holder 111 and the objective lens 112 to move rightward.

Referring to FIG. 9, when a reversed current a2 is input into the tracking coil 121, the tracking coil 121 will generate a Lorentz Force in the reverse direction, so as to drive the coil plate 120 to move leftward along the tracking axis T, and simultaneously drive the lens holder 111 and the objective lens 112 to move leftward.

Referring to FIG. 7, the effective coil areas 122a of the focusing coil 122 overlap the bordering part of the second pole 132 and the third pole 133 in the tracking axis T. A current is input into the focusing coil 122 for generating a Lorentz Force. The direction of the force, named Lorentz Force, is changed by controlling the current direction input into the focusing coil 122, so as to drive the coil plate 120 to move along the focusing axis F.

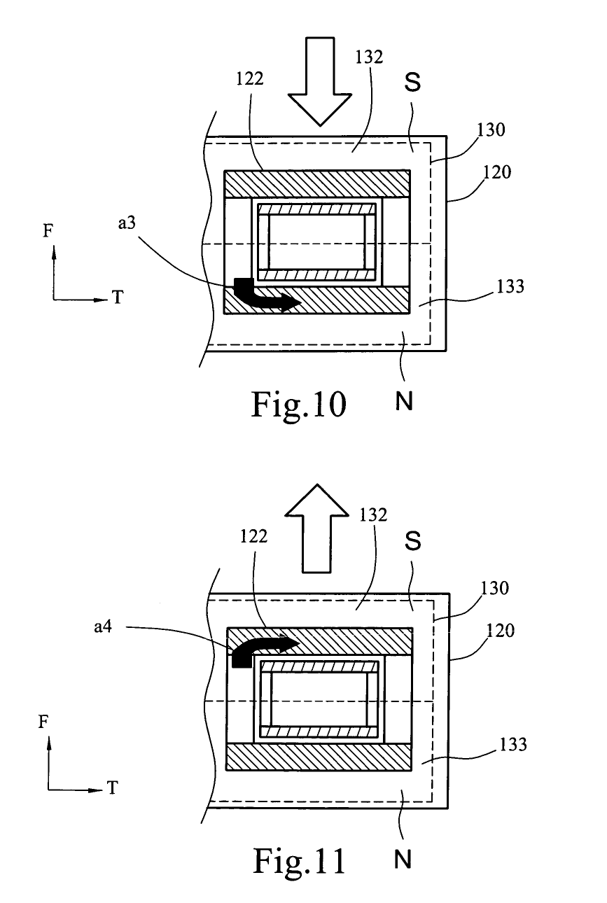

Referring to FIG. 10, when a current a3 is input in the focusing coil 122, generating the Lorentz Force, the focusing coil 122 drives the coil plate 120 to move downward along the focusing axis F, and simultaneously drives the lens holder 111 and the objective lens 112 to move downward.

Referring to FIG. 11, when a reversed current a4 is input into the focusing coil 122, generating the Lorentz Force in a reverse direction, the focusing coil 122 moves the coil plate 120 upward along the focusing axis F, and simultaneously moves the lens holder 111 and the objective lens 112 upward for focusing action.

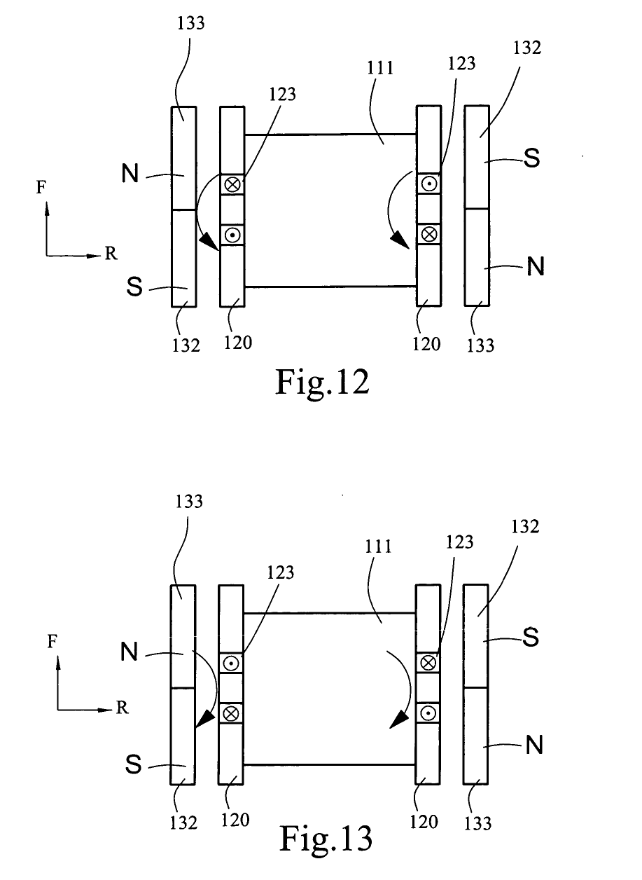

Referring to FIG. 12 and FIG. 13, they are schematic side views of the lens holder 111, the coil plate 120, and the multi-polar magnet 130. When tilting, the two coil plates 120 cooperate with each other, and are subjected to the upward and downward external forces respectively, so as to form a couple and move the lens holder 111 to tilt. In the embodiment, two multi-polar magnets 130 are in the same form. They are disposed on the two sides of the lens holder 111 in a symmetric pattern with opposite directions of upper and lower. That is, as viewed from the side, a multi-polar magnet 130 adopts the arrangement that the second pole 132 is in downside and the third pole 133 is in upside, while the other multi-polar magnet 130 adopts the arrangement that the second pole 132 is in upside and the third pole 133 is in downside. The two coil plates 120 are also arranged in the pattern of left and right symmetry. The effective coil area of the tilting coil 123 overlaps the second pole 132 and the third pole 133. When currents having the same direction are input into the two tilting coils 123, the directions of force of the two tilting coils 123 will be respectively upward and downward, so as to drive the lens holder 111 to generate a movement of tilting. Actually, the focusing coil 122 and the tilting coil 123 can randomly interchange the functions by different forcing forms. That is, when the force directions of the coils are the same, the lens holder can be moved in straight line, so as to be moved along the focusing axis F. When the force directions of the coils located on the two sides of the lens holder 111 are different, a couple is generated, so as to drive the lens holder 111 tilting.

### The Second Embodiment

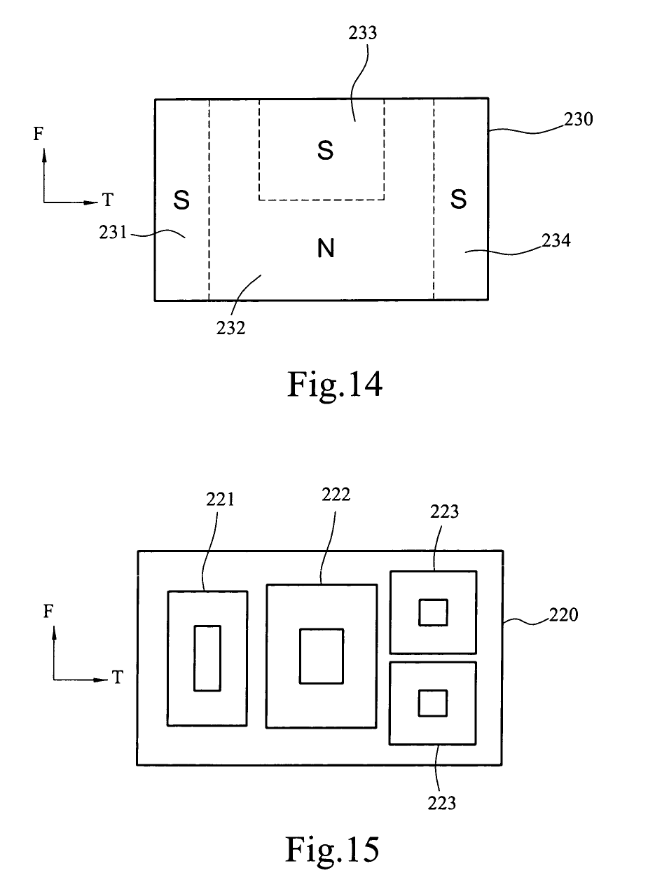

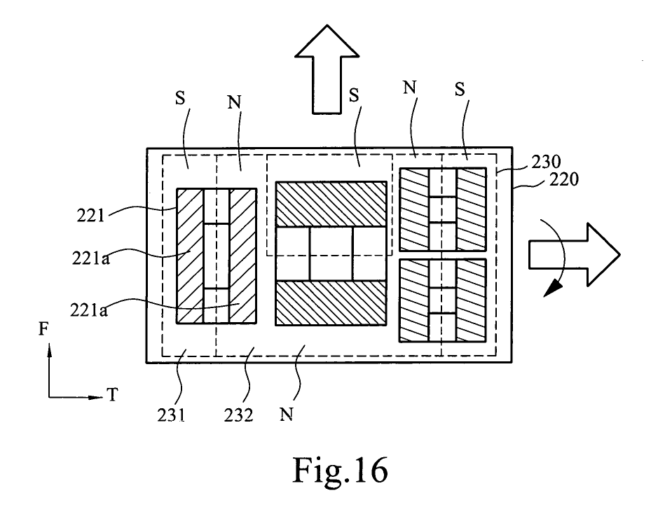

Referring to FIG. 14, FIG. 15, and FIG. 16, an objective lens actuating apparatus of a second embodiment of the present invention is provided, and another corresponding pattern of multi-polar magnets and coil plates are disclosed. FIG. 14 is a schematic view of the arrangement of the poles of the multi-polar magnet 230, FIG. 15 is a schematic view of the arrangement of the tracking coil 221, the focusing coil 222, and the tilting coil 223 on the coil plate 220, and FIG. 16 is a schematic view in which the poles of the multi-polar magnet 230 correspond to each coil on the coil plate 220.

The multi-polar magnet 230 is divided into a first pole 231, a second pole 232, a third pole 233, and a fourth pole 234. The first pole 231 and the fourth pole 234 are located on the two edges of the multi-polar magnet 230 and adjacent to the second pole 232. The border between the first pole 231 and the second pole 232 is parallel to the focusing axis F. The border between the fourth pole 234 and the second pole 232 is parallel to the focusing axis F as well. The second pole 232 is in the shape of U, such that the third pole 233 is half-surrounded by the second pole 232, and at least one border between the second pole 232 and the third pole 233 is parallel to the tracking axis T.

The coil plate 220 has a tracking coil 221, a focusing coil 222, and two tilting coils 223. The tracking coil 221 is in the shape of a oval or rectangle, and the length of the tilting coils 223 in the focusing axis F is greater than the length of the tilting coils 223 in the tracking axis T. The tracking coil 221 is adjacent to a side edge of the coil plate 220. The focusing coil 222 can be of rectangle, round, rectangle, or oval in shape and is located in the middle of the coil plate 220. The two tilting coils 223 are located adjacent to the other side edge of the coil plate 220 and aligned with each other along the focusing axis F.

The functions of the tracking coil 221 and the focusing coil 222 are the same as that of the first embodiment. The effective coil areas 221a of the tracking coil 221 overlap the first pole 231 and the second pole 232. A current is input into the tracking coil 221, generating a Lorentz Force, for driving the coil plate 220 to move along the tracking axis T. The effective coil areas 222 of the focusing coil 222 overlap the second pole 232 and the third pole 233. A current is input into the focusing coil 222, generating force, for driving the coil plate 220 to move along the focusing axis F.

The function and the action of the tilting coil 223 are different from that of the first embodiment. In the second embodiment, each coil plate 220 respectively has two tilting coils 223 overlapping the second pole 232 and the fourth pole 234. When currents with different directions are input into the two tilting coils 223, such that the tilting coils 223 generate Lorentz Forces in different directions, and a couple is generated to drive the lens holder (not shown) tilting. The tilting angle of the lens holder is greater and the speed of response is quicker than those in the first embodiment by the two tilting coils 223.

### The Third Embodiment

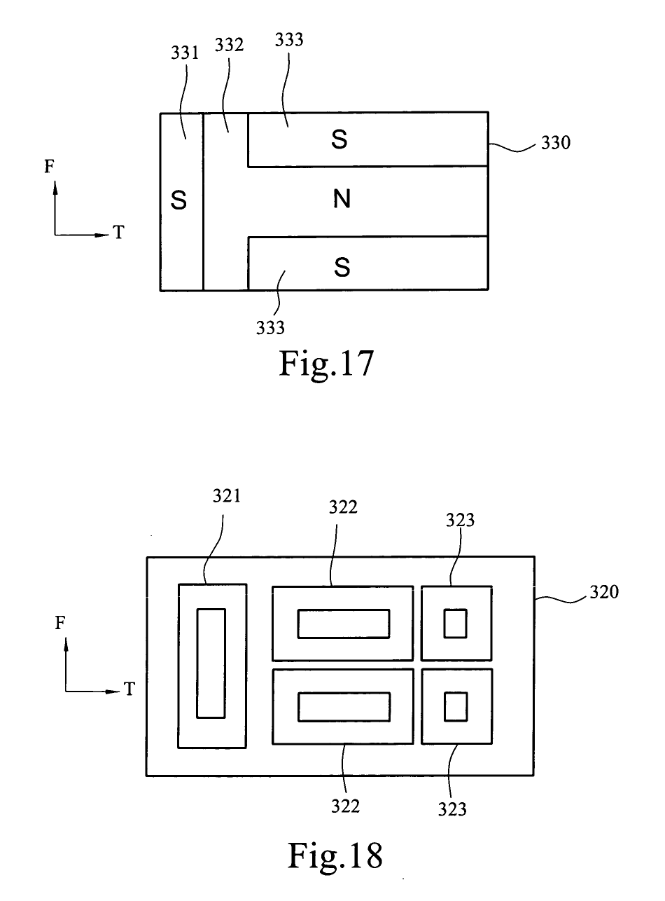

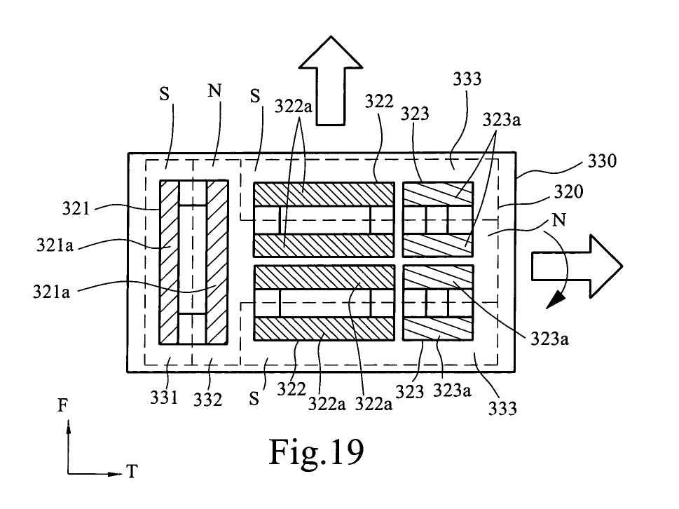

Referring to FIG. 17, FIG. 18, and FIG. 19, an objective lens actuating apparatus of a third embodiment of the present invention is provided, and another corresponding pattern of the multi-polar magnet and the coil plate are disclosed. FIG. 17 is a schematic view of the arrangement of the poles of the multi-polar magnet 330, FIG. 18 is a schematic view of the arrangement of the tracking coil 321, the focusing coil 322, and the tilting coil 323 on the coil plate 320, FIG. 19 is a schematic view in which the poles of the multi-polar magnet 330 correspond to each coil on the coil plate 320.

The multi-polar magnet 330 is divided into a first pole 331, a second pole 332, and two third poles 233. The first pole 331 is located near one edge of the multi-polar magnet 330 and adjacent to the second pole 332. The border between the first pole 331 and the second pole 332 is parallel to the focusing axis F. The second pole 332 is in the shape of T, and has a long portion extending along the tracking axis T. The two third poles 333 are extending along the tracking axis T, and respectively located over and under the portion extending along the tracking axis T of the second pole 332. The borders between the second pole 332 and the two third poles 333 are parallel to the tracking axis T.

The tracking coil 321 is approximately the same as that of the first embodiment. Its effective coil areas 321a overlap the first pole 331 and the second pole 332. After a current is input into the tracking coil 321, a force is generated to drive the coil plate 320 along the tracking axis T.

In the third embodiment, each of the coil plates 320 has two focusing coils 322. The effective coil areas 322a of one of the two focusing coils 322 overlap the second pole 332 and a third pole 333. The effective coil areas 322a of the other focusing coil 322 overlap the second pole 332 and the other third pole 333. Currents in different directions are input into the two focusing coils 322, and the two focusing coils 322 interact with the second pole 332 and the third pole 333 to generate Lorentz Force. Since the relative positions of the second pole 332 and the third pole 333 corresponding to the two focusing coils 322 are opposite, when the magnetic polarities of the two focusing coils 322 facing the multi-polar magnet 330 are different, the two focusing coils 322 generates forces with different directions, upward and downward along the focusing axis F.

In the third embodiment, each of the coil plates 320 has two tilting coils 323. The effective coil areas 323a of one of the two tilting coils 323 overlap the second pole 332 and a third pole 333. The effective coil areas 323a of the other tilting coil 323 overlap the second pole 332 and the other third pole 333. When currents in different directions are input in the two tilting coils 323, since the relative positions of the second pole 332 and the third pole 333 corresponding to the two tilting coils 323 are opposite, the directions of forces generated by the two tilting coils 323 are be the same, so as to drive the coil plate 320 to move upward and downward along the focusing axis F. At this time, as long as the coil plates 320 located on the two sides of the lens holder (not shown) generate forces in different directions, a couple function is generated to drive the lens holder tilting.

### The Fourth Embodiment

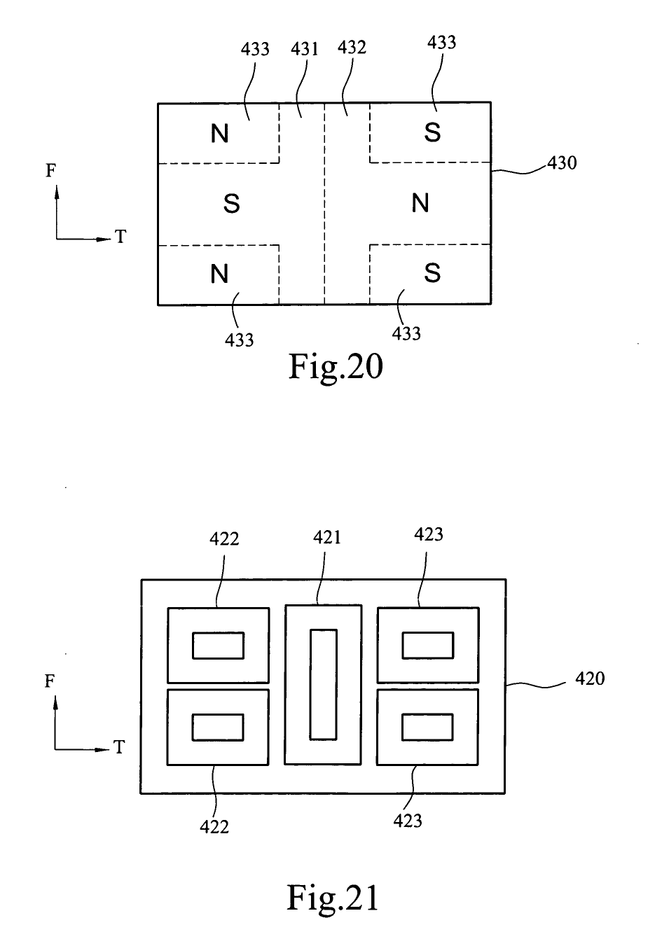

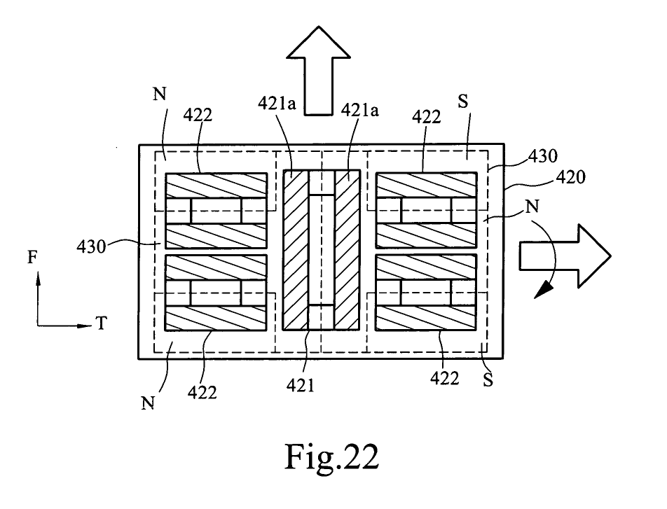

Referring to FIG. 20, FIG. 21, and FIG. 22, an objective lens actuating apparatus of a fourth embodiment of the present invention is provided, and another corresponding pattern of the multi-polar magnet and the coil plate are disclosed. FIG. 20 is a schematic view of the arrangement of the poles of the multi-polar magnet 430, FIG. 21 is a schematic view of the arrangement of the tracking coil 421, the focusing coil 422, and the tilting coil 423 on the coil plate 420, FIG. 22 is a schematic view in which the poles of the multi-polar magnet 430 correspond to each coil on the coil plate 420.

The multi-polar magnet 430 is divided into a first pole 431, a second pole 432, and four third poles 433. The first pole 431 and the second pole 432 are in the shape of T placed horizontally. The first pole 431 is polarized into an S magnetic polarity, and the second pole 432 is polarized into N magnetic polarity. The first pole 431 has a long portion extending leftward along the tracking axis T. The second pole 432 has a long portion extending rightward along the tracking axis T. The first pole 431 and the second pole 432 are adjacent to each other in the middle region of the multi-polar magnet 430. The portions adjacent to each other of the first pole 431 and the second pole 432 extends upward and downward along the focusing axis F, thus the border between the first pole 431 and the second pole 432 is parallel to the focusing axis F.

The third poles 433 are respectively located on the four corners of the multi-polar magnet. The two third poles 433, located on the left of the figure, are adjacent to the first pole 431 and are polarized into N magnetic polarities, with at least one border parallel to the tracking axis T. The two third poles 433, located on the right of the figure, are adjacent to the second pole 432 and are polarized into S magnetic polarities, with at least one border parallel to the tracking axis T.

The coil plate 420 has a tracking coil 421 and four focusing coils 422. The tracking coil 421 is located in the middle of the coil plate 420, corresponding to the middle of the multi-polar magnet 420, such that the effective coil areas 421a of the tracking coil 421 overlap the first pole 431 and the second pole 432. A current is input into the tracking coil 421, generating Lorentz Force function, so as to drive the coil plate 420 to move along the tracking axis T.

The four focusing coils 422 are respectively located on the four corners of the coil plate 420. The two focusing coil 422, located on the left of the figure, overlap the adjacent portions of the first pole 431 and the third pole 433. The two focusing coil 422, located on the right of the figure, overlap the adjacent portions of the second pole 432 and the third pole 433. Currents are input into the focusing coils 422 to drive the coil plate 420 to move upward and downward along the focusing axis F. For moving the lens holder (not shown) upward and downward along the focusing axis F, the directions of forces in the focusing axis F generated by the coil plate 420 located on the two sides of the lens holder are the same. For driving the lens holder tilting, the directions of forces in the focusing axis F generated by the coil plates 420 located on the two sides of the lens holder are opposite, and a couple is generated for driving the lens holder tilting.

In the present invention, the focusing coil and the tilting coil can be interchanged. Or through a group of coils and changing of the directions of forces applied onto the two sides of the lens holder, a linear force or a couple applied in the is generated. Taking the fourth embodiment as an illustration, the focusing coils on the two coil plate can generate forces with the same direction simultaneously, so as to drive the lens holder to move in the focusing axis F. The focusing coils on the two coil plate can also generate forces with opposite directions, so as to drive the lens holder to tilt. The four focusing coils can also be categorized, with two of them to drive the lens holder focusing, and the other two focusing coils to serve as the tilting coils to drive the lens holder tilting.

### The Fifth Embodiment

The arrangements of the multi-polar magnets and the plane coils of the first, second, third, and fourth embodiment are symmetric. That is, two multi-polar magnets and the plane coils have the same pattern. However, the plane coils and the multi-polar magnets can also be a combination of different patterns, so as to represent asymmetric.

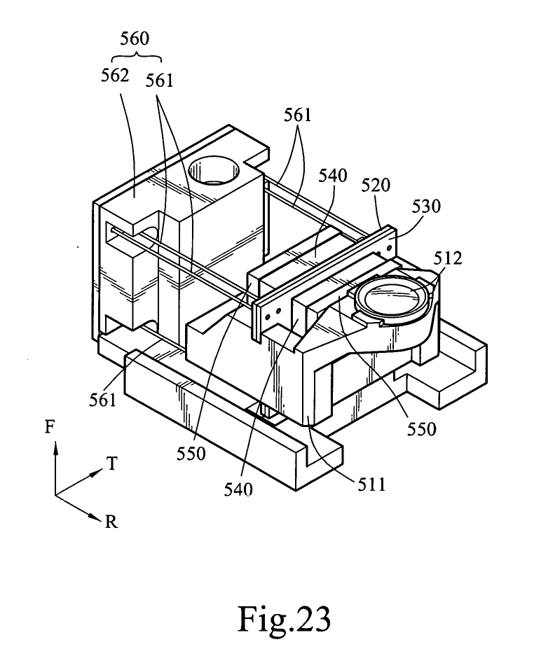

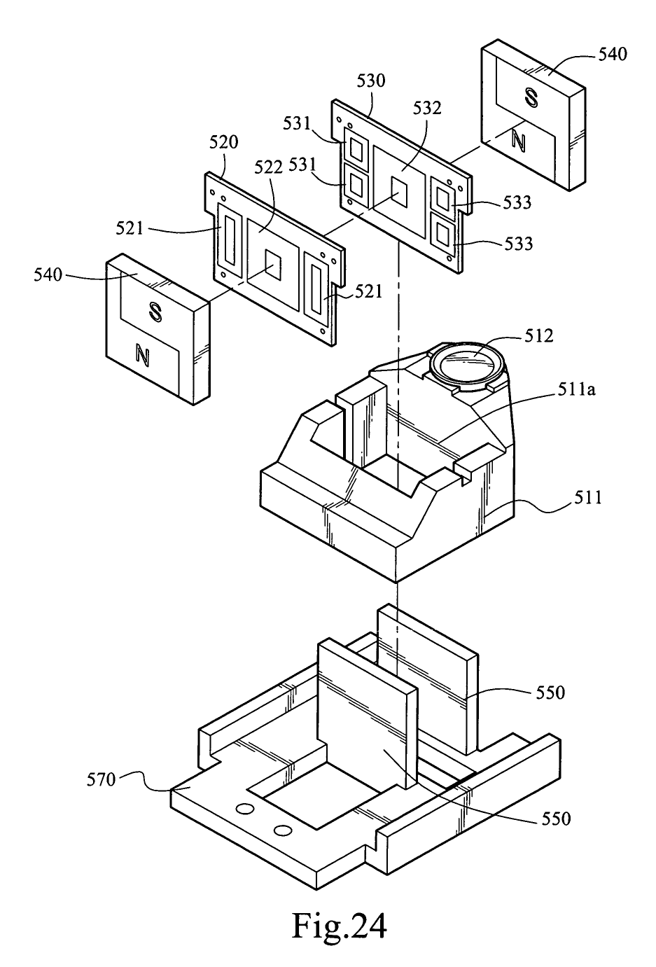

Referring to FIG. 23 and FIG. 24, an objecting lens actuating apparatus of a fifth embodiment of the present invention is provided, which comprises an lens holder 511, an objective lens 512, a first coil plate 520, a second coil plate 530, two multi-polar magnets 540, two yokes 550, a supporting device 560, and a base 570. For illustrating, a focusing axis F extending from top to bottom, a tracking axis T parallel to the coil plate, a normal direction R of the plate vertical to the focusing axis F and the tracking axis T are defined in the figures.

The objective lens 512, being parallel to the T-R plane, is fixed on the lens holder 511. It is moved with the lens holder 511 and carries out focusing, tracking, and tilting actions.

The lens holder 511 has a hollow accommodation portion 511a, and the first coil plate 520 and the second coil plate 530 are fixed in the hollow accommodation portion 511a.

The first coil plate 520 has two tracking coils 521 and a focusing coil 522. These coils respectively correspond to the different poles on the multi-polar magnet 540.

The second coil plate 530 has two tracking coils 531, a focusing coil 532, and two tilting coils 533. Also, these coils-respectively correspond to the different poles on the other multi-polar magnet 540.

The supporting device 560 comprises a plurality of copper wires 561 and a holding seat 562, wherein each copper wire 561 penetrates through two sides of the lens holder 511, with one end connected to the holding seat 562 so as to receive the current input, and the other end connected to different coils so as to transmit the current into the coils for generating magnetic force. The holding seat 562 is disposed on one side of the base 570, such that the lens holder 511 can be supported by the copper wires 562, floating over the base 570 in parallel.

Two yokes 550 are disposed in the center of the top side of the base 570, just located in the accommodation portion 511a of the lens holder 511. Each multi-polar magnet 540 is respectively mounted onto the inner sides of the two yokes 550. The first coil plate 520 and the second coil plate 530 are in contact with each other, and are sandwiched between the two multi-polar magnets 540 simultaneously, such that each coil corresponds to the two multi-polar magnets 540. Because the first coil plate 520 and the second coil plate 530 are in contact with each other, only one multi-polar magnet 540 is needed to act on the first coil plate 520 and the second coil plate 530 simultaneously.

With the supporting of the supporting device 560, the lens holder 511 together with the first coil plate 520, the second coil plate 530, and the objective lens 512 float over the base 570. By inputting currents into each coil on the first coil plate 520 and the second coil plate 530, the coils can interact with the different poles of the multi-polar magnets 540, and generate Lorentz Force. By arranging the force directions of the coils, the first coil plate 520 and the second coil plate 530 are driven by the Lorentz Force, and perform vertical and horizontal moving, tilting, and other actions.

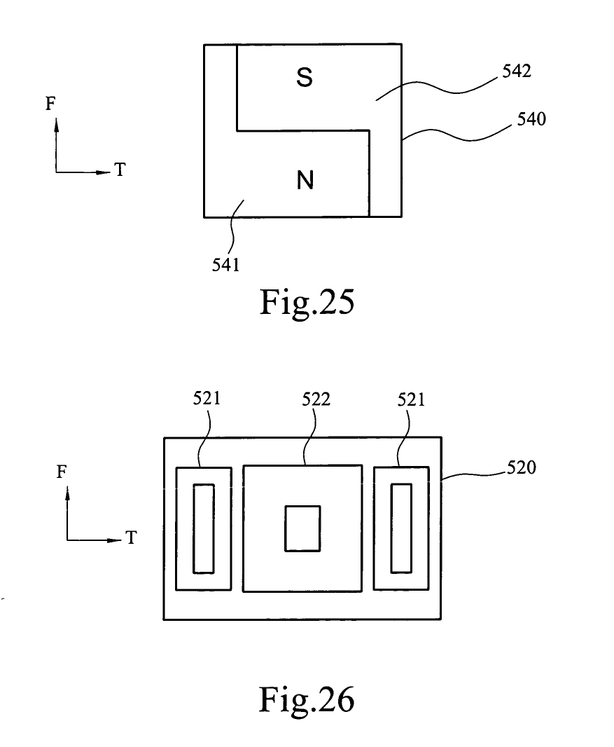

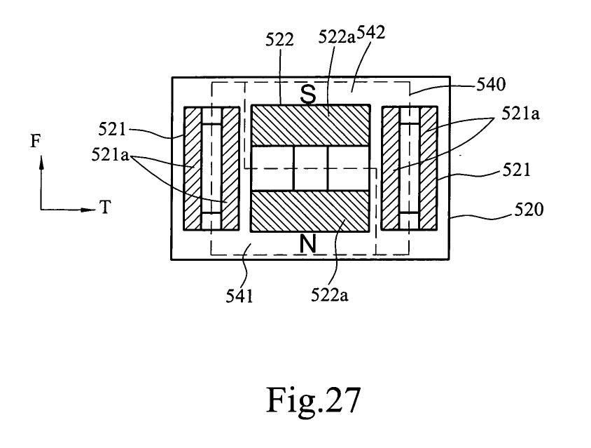

Referring to FIG. 25, FIG. 26, and FIG. 27, wherein FIG. 25 is a schematic view of the arrangement of the poles of the multi-polar magnet 540, FIG. 26 is a schematic view of the arrangement of the two tracking coils 521 and the focusing coil 522 on the first coil plate 520, and FIG. 27 is a schematic view in which the poles of the multi-polar magnet 540 correspond to each coil on the first coil plate 520.

The two tracking coil 521 and the focusing coil 522 of the first coil plate 520 are wound parallel to the surface of the first coil plate 520 (parallel to the T-F plane), and they can be wound as a single layer or multiple layers. The tracking coil 521 is in the shape of an oval or rectangle, and the length of the tracking coil 521 in the focusing axis F is greater than the length in the tracking axis T, and their positions are respectively near the two edges of the first coil plate 520. The focusing coil 522 is also wound in the direction parallel to the first coil plate 520 (parallel to the T-F plane), and its position is approximately at the center of the first coil plate 520.

The multi-polar magnet 540 has a first pole 541 and a second pole 542. The first pole 541 and the second pole 542 are respectively located in the upper part and the lower part of the multi-polar magnet 540. The first pole 541 has a long portion extending along the focusing axis F towards one side of the second pole 542, and the second pole 542 also has a long region extending along the focusing axis F towards one side of the first pole 541, such that there are a border parallel to the tracking axis T and two borders parallel to the focusing axis F between the first pole 541 and the second pole 542.

Referring to FIG. 27, the effective coil areas 521a of the tracking coil 521 of the first coil plate 520 overlap the border in the tracking axis T of the first pole 541 and the second pole 542. After a current is input into the tracking coil 521, a Lorentz Force is generated. By controlling the direction of the current, the direction of the force generated by the tracking coil 521 is changed, such that the Lorentz Force can be used to drive the first coil plate 520 to move.

Again, referring to FIG. 27, the effective coil areas 522a of the focusing coil 522 of the first coil plate 520 overlap the adjacent portions of the second pole 542 and the third pole 543 in the tracking axis T. When a current is input into the focusing coil 522, generating the Lorentz Force, the focusing coil 522 drives the first coil plate 520. The direction of the gererated by the focusing coil 522 is changed by controlling the current direction input into the focusing coil 522, so as to drive the first coil plate 520 to move along the focusing axis F.

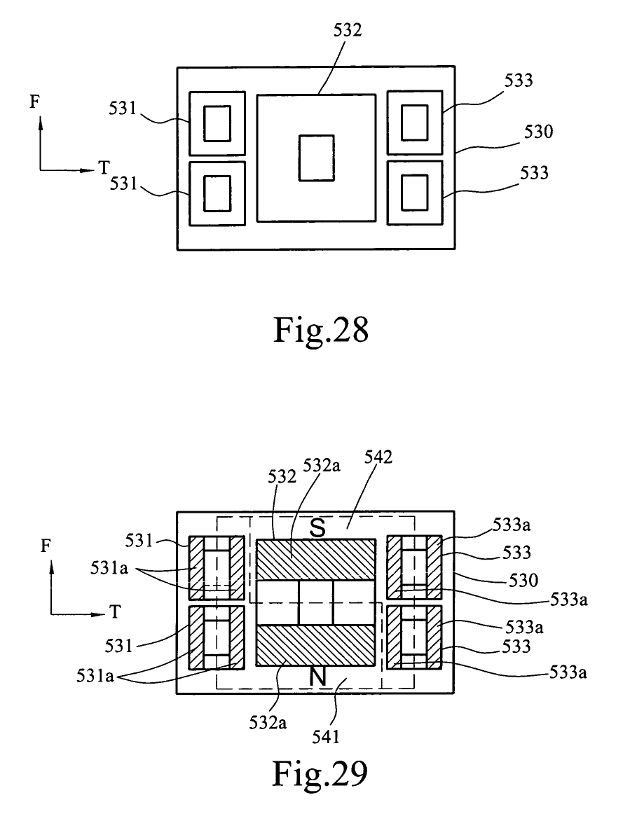

Referring to FIG. 28 and FIG. 29, wherein FIG. 28 is a schematic view of the arrangement of two tracking coils 531, a focusing coil 532, and two titling coils 533 on the second coil plate 530, and FIG. 29 is a schematic view in which the poles of the multi-polar magnet 540 correspond to each coil on the second coil plate 530.

The two tracking coils 531 of the coil plate 530 are located near one side edge of the second coil plate 530. The focusing coil 532 is located at the center of the second coil plate 530. The two tilting coils 530 are located near the other side edge of the second coil plate 530.

Referring to FIG. 28, the effective coil areas 531a of the two tracking coils 531 of the second coil plate 530 overlap the adjacent portions of the first pole 541 and the second pole 542 in the tracking axis T. After a current is input into the tracking coils 531, a Lorentz Force is generated. By controlling the direction of the current, the direction of force generated by the tracking coils 531 is changed, so as to drive the second coil plate 530 to move along the tracking axis T.

Referring to FIG. 28, the effective coil areas 532a of the focusing coil 532 of the second coil plate 530 overlap the adjacent portions of the second pole 542 and the third pole 543 in the tracking axis T. After a current is input into the focusing coil 532, a Lorentz Force is generated. By controlling the direction of the current, the direction of the force generated by the focusing coil 532 is changed, so as to drive the second coil plate 530 to move along the focusing axis F.

Referring to FIG. 28 again, the effective coil areas 533a of the two tilting coils 533 of the second coil plate 530 overlap the adjacent portions of the first pole 541 and the second pole 542 in the tracking axis T. After a current is input into the tracking coils 543, a Lorentz Force is generated. By controlling the direction of current, the direction of generated by the tracking coil 543 is changed, so as to applied the force to the second coil plate 530 in the tracking axis T.

For driving the lens holder 511 moving in the focusing axis F, namely focusing, currents are input into the focusing coils 522, 532 of the first coil plate 520 and the second coil plate 530. Forces generated by the two focusing coils 522, 532 are in the focusing axis F, and the forces are applied to the first coil plate 520 and the second plate 530 in the same direction, the focusing axis F, so as to drive the lens holder 511 to move upward and downward in the focusing axis F.

For driving the lens holder 511 moving in the tracking axis T, namely tracking, currents are input into the tracking coils 521, 531 of the first coil plate 520 and the second coil plate 530. Forces generated by the two tracking coils 521, 531 are in the tracking axis F, and the forces are applied to first coil plate 520 and the second plate 530 will in the same direction, the tracking axis T, so as to drive the lens holder to move upward and downward in the tracking axis T.

For driving the lens holder 511 is tilting, currents with different directions are input in the tilting coils 531 of the second coil plate 530. The directions of forces generated by the two tilting coils 531 in the focusing axis F are opposite, such that a couple is generated to rotate the second coil plate 530. Because the second coil plate 530 is fixed at the center of the lens holder 511, the lens holder 511 is driven for tilting.

The patterns of the first coil plate and the second coil plate can be varied randomly, and meanwhile the coils with different functions can be arranged randomly on each coil plate. It is not necessary to disposed two coil plates at the same time, only one coil plate can be functioned as needed. That is, located one coil plate in the center of the lens holder, therefore, the lens holder can be driven by straight driven force and the couple generated by the coil plate and the multi-polar magnet to carry out tracking, focusing, tilting, and other actions.

### The Sixth Embodiment

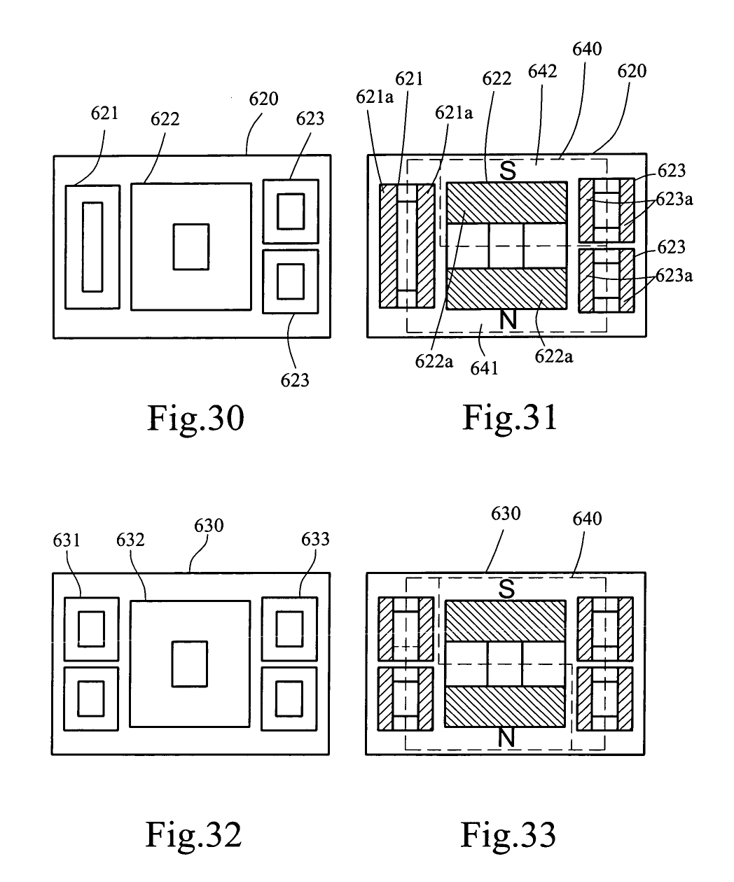

Referring to FIG. 30, FIG. 31, FIG. 32, and FIG. 33, an objective lens actuating apparatus of a sixth embodiment of the present invention is provided, and another corresponding pattern of the multi-polar magnet and the coil plate are disclosed. FIG. 30 is a schematic view of the arrangement of the tracking coil 621, the focusing coil 622, and two titling coils 623 on the first coil plate 620, FIG. 31 is a schematic view in which the poles of the multi-polar magnet 640 correspond to each coil on the first coil plate 620, FIG. 32 is a schematic view of the arrangement of two tracking coils 631, the focusing coil 632, and two titling coils 633 on the second coil plate 630, and FIG. 33 is a schematic view in which the poles of the multi-polar magnet 640 correspond to each coil on the second coil plate 630.

Referring to FIG. 32 and FIG. 33, the pattern of the second coil plate 630 and its correspondence with each poles of the multi-polar magnet 640 are the same as that of the fifth embodiment, which will not be described again. Only the first coil plate 620 is illustrated in this embodiment.

Referring to FIG. 30, the tracking coil 621 of the first coil plate 620 is in the shape of an oval or rectangle, the length of the tracking coil 621 in the focusing axis F is greater than the length in the tracking axis T, and it is located near one side edge of the first coil plate 620. The focusing coil 622 is located at the center of the first coil plate 620. The two tilting coils 620 are located near the other side edge of the first coil plate 620.

Referring to FIG. 31, the multi-polar magnet 640 has a first pole 641 and a second pole 642. The first pole 641 and the second pole 642 are respectively located in the upper part and the lower part of the multi-polar magnet 640. The first pole 641 has a long portion extending along the focusing axis F to a side edge of the second pole 642. The second pole 642 also has a long portion extending along the focusing axis F to a side edge of the first pole 641. Thus, a border between the first pole 641 and the second pole 642 is parallel to the tracking axis T and two borders between the first pole 641 and the second pole 642 are parallel to the focusing axis F.

Again, referring to FIG. 31, the effective coil areas 621a of the tracking coil 621 of the first coil plate 620 overlap the adjacent portions of the first pole 641 and the second pole 642 in the tracking axis T. After a current is input into the tracking coil 621, a Lorentz Force is generated. The direction of the force generated by the tracking coil 621 is changed by controlling the current direction, so as to drive the first coil plate 620 to move in the tracking axis T.

The effective coil areas 622a of the focusing coil 622 of the first coil plate 620 overlap the adjacent portions of the second pole 642 and the third pole 643 in the tracking axis T. After a current is input into the focusing coil 622, a Lorentz Force is generated. The direction of force generated by the focusing coil 622 is changed by controlling the current direction, so as to drive the first coil plate 620 to move along the focusing axis F.

The effective coil areas 623a of the two tilting coils 623 of the first coil plate 620 overlap the adjacent portions of the first pole 641 and the second pole 642 in the tracking axis T. After a current is input into the tracking coil 623, a Lorentz Force is generated. Currents with different directions are input into the two tilting coils 623 of the first coil plate 620, such that the force directions of the two tilting coils 531 in the tracking axis T are opposite, thus a couple is generated to rotate the first coil plate 620. Because the first coil plate 620 is fixed at the center of the lens holder (not shown), the lens holder can be driven for tilting.

The first coil plate 620 can drive the lens holder alone, and also can drive the lens holder together with the second coil plate 630. The patterns of the first coil plate 620 and the second coil plate 630 are not limited to the combinations of the fifth embodiment and the sixth embodiment, and combinations of coil plates with different patterns can also be used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An objective lens actuating apparatus, comprising:
a base;
a lens holder floating over the base;
an objective lens fixed on the lens holder;
at least a multi-polar magnet fixed on the base and having a plurality of magnetic poles; and
two coil plates fixed in the lens holder and located between the multi-polar magnets, wherein each coil plate respectively has a tracking coil, a focusing coil, and a tilting coil;
wherein the tracking coil, the focusing coil, and the tilting coil generate forces for driving the lens holder tracking, focusing, and tilting after currents are input into the tracking coil, the focusing coil, and the tilting coil, and the direction of the forces are changed by controlling the direction of currents input into the tracking coil, the focusing coil, and the tilting coil.

2. The objective lens actuating apparatus as claimed in claim 1, further comprising two yokes, wherein the multi-polar magnet is fixed on an inner side of one of the yokes.

3. The objective lens actuating apparatus of claim 1, wherein the tracking coil, the focusing coil, and the tilting coil respectively overlap two of the poles adjacent to each other of the multi-polar magnet.

4. The objective lens actuating apparatus of claim 1, wherein the focusing coil surrounds the periphery of the tilting coil.

5. The objective lens actuating apparatus of claim 1, wherein the multi-polar magnet comprises a first pole, a second pole, and a third pole, the tracking coil overlaps the first pole and the second pole, the focusing coil overlaps the second pole and the third pole, and the tilting coil overlaps the second pole and the third pole.

6. The objective lens actuating apparatus of claim 1, wherein the multi-polar magnet comprises a first pole, a second pole, a third pole, and a fourth pole, wherein:
the first pole and the fourth pole are located on the two edges of the multi-polar magnets, and adjacent to the second pole;
the third pole is half-surrounded by the second pole; and
the coil plate has a tracking coil, a focusing coil, and two tilting coils, the tracking coil overlaps the first pole and the second pole; the focusing coil overlaps the second pole and the third pole; and each titling coil overlaps the second pole and the fourth pole.

7. The objective lens actuating apparatus of claim 1, wherein the multi-polar magnet has a first pole, a second pole, and two third poles; and the coil plate has a tracking coil, two focusing coils, and two tilting coils, such that the tracking coil overlaps the first pole and the second pole, one of the focusing coils and tilt coils overlaps the second pole and one of the third poles, and the other focusing coil and tilt coils overlaps the second pole and the other third pole.

8. The objective lens actuating apparatus of claim 7, wherein the first pole is located near one side edge of the multi-polar magnet and adjacent to the second pole, the second pole is T-shaped with an extended long portion, and the two third poles are respectively located over and under the extended long region of the second pole.

9. An objective lens actuating apparatus, comprising:
a base;
a lens holder floating over the base;
an objective lens fixed on the lens holder;
two multi-polar magnets disposed on the base and each having a plurality of poles; and
two coil plates, mounted onto the lens holder, and each coil plate located between the two multi-polar magnets, wherein each coil plate respectively has a tracking coil, and a plurality of tilting coils, that the tracking coil and the tilting coils overlap different poles of each multi-polar magnet;

10. The objective lens actuating apparatus of claim 9, the apparatus further comprising two yokes, wherein each multi-polar magnet is fixed on an inner side of each yoke.

11. The objective lens actuating apparatus of claim 9, wherein each coil plate is mounted onto two sides of the lens holder, and the lens holder and each coil plate are located between the two multi-polar magnets.

12. The objective lens actuating apparatus of claim 9 wherein the tracking coil, the focusing coil, and the tilting coil respectively overlap two of the poles adjacent to each other of the multi-polar magnets.

13. The objective lens actuating apparatus of claim 9, wherein the multi-polar magnet has a first pole, a second pole, and the four third poles; and one of the coil plates has a tracking coil and two focusing coils and two tilting coils, such that the tracking coil overlaps the first pole and the second pole, two of the focusing coils overlap the first pole and two of the third poles, and the two tilting coils overlap the second pole and the other two third poles.

14. The objective lens actuating apparatus of claim 13, wherein the first pole and the second pole are in the shape of T, and the first pole has a long portion extending toward one side of the multi-polar magnet, the second pole has a long portion extending toward one side of the multi-polar magnet, wherein the first pole and the second pole are adjacent to each other at the middle of the multi-polar magnet; and each third pole is located in the four corners of the multi-polar magnet, and respectively adjacent to the first pole and the second pole.

15. An objective lens actuating apparatus, comprising:
a base;
an lens holder floating over the base;
an objective lens fixed on the lens holder;
at least a multi-polar magnets fixed on the base and having multiple a plurality of poles;
a first coil plate mounted onto the lens holder, having a tracking coil, and a focusing coil, that the tracking coil and the focusing coil overlap different poles of the multi-polar magnet, and
a second coil plate mounted onto the lens holder, having a tracking coil, a focusing coil, and a plurality of tilting coils, that the tracking coil, the focusing coil, and the tilting coils overlap different poles of the multi-polar magnet, wherein the tracking coil, the focusing coil, and the tilting coils overlap different poles of the multi-polar magnet.

16. The objective lens actuating apparatus of claim 15, further comprising two yokes, wherein the multi-polar magnets is fixed on an inner side of one of the yokes.

17. The objective lens actuating apparatus of claim 15 wherein the coil plates are fixed in the middle of the lens holder.

18. The objective lens actuating apparatus of claim 15, wherein each tracking coil, each focusing coil, and each tilting coil respectively overlaps two of the poles adjacent to each other of the multi-polar magnet.

19. The objective lens actuating apparatus of claim 15, wherein the multi-polar magnet has a first pole and a second pole, which are respectively located in the upper part and the lower part of the multi-polar magnet, and the first pole has a long portion extending to a side edge of the second pole; the second pole also has a long portion extending to a side edge of the first pole.

20. The objective lens actuating apparatus of claim 19, wherein the focusing coil and the tracking coil of the first coil plate overlap the different borders between the first pole and the second pole.

21. The objective lens actuating apparatus of claim 19, wherein each tracking coil, each focusing coil, and each tilting coil overlap the different borders between the first pole and the second pole.
